(19) United States
(12) Patent Application Publication
(10) Pub. No.: US 2026/0320589 A1
(43) Pub. Date: Oct. 15, 2026

(54) INFORMATION PROCESSING APPARATUS, INFORMATION PROCESSING METHOD, AND INFORMATION PROCESSING PROGRAM

(71) Applicant: FELICA NETWORKS, INC, TOKYO (JP)

(72) Inventors: HIROTAKA TSUDA, TOKYO (JP); AYA KOBAYASHI, TOKYO (JP); SATOSHI YUI, TOKYO (JP)

(21) Appl. No.: 19/104,322

(22) PCT Filed: Aug. 14, 2023
(86) PCT No.: PCT/JP2023/029392

§ 371 Date: Feb. 17, 2025

(30) Foreign Application Priority Data
Aug. 24, 2022 (JP) 2022-133565

(51) Int. Cl. G06Q 20/36; G06Q 20/40

(52) U.S. Cl. CPC G06Q 20/3676; G06Q 20/40

(57) ABSTRACT

An information processing apparatus according to one embodiment of the present disclosure includes a management unit configured to manage a balance obtained by totaling electronic money balances held by a plurality of terminal apparatuses each being equipped with an electronic money function, as one balance to be shared among the plurality of terminal apparatuses; and an update unit configured to update balance such that, in a case where electronic payment with the electronic money has been made using one terminal apparatus controlled to be in an electronic payment enabled mode among the plurality of terminal apparatuses, the update unit updates an amount of money obtained by subtracting an amount of used money in the electronic payment from the one balance, as a latest record of the one balance to be shared among the plurality of terminal apparatuses.

### FIELD

The present invention relates to an information processing apparatus, an information processing method, and an information processing program.

### BACKGROUND

Apparatuses being developed in recent years include a terminal apparatus having a near-field (close proximity) wireless communication function by a non-contact integrated circuit (IC) chip mounted on the apparatus and being capable of performing wireless communication with a reader/writer in close proximity about several centimeters, for example.

For example, with a secure element included in the IC chip performing optionally selected processing in association with near-field wireless communication, the terminal apparatus can implement a ticket function for transportation, a credit card function, and a personal authentication card function, in addition to an electronic money function.

Here, in an example of the electronic money function, payment processing is performed by associating money information referred to as value with a monetary value and increasing or decreasing the balance of the value. In such electronic payment, there is a need to share values among a plurality of terminal apparatuses, and in order to implement value sharing, it is necessary to constantly synchronize the record of balance without causing conflict in payment processing.

For example, Patent Literature 1 proposes a technique for sharing electronic money between a plurality of terminal apparatuses.

### CITATION LIST

### Patent Literature

Patent Literature 1: JP 2015-197891 A.

### SUMMARY

### Technical Problem

However, the above-described known technique is not necessarily capable of performing the electronic money function with high usability without causing mutual conflict in payment processing among the plurality of terminal apparatuses.

For example, in the above-described known technique, when performing electronic payment with electronic money in a state where pairing is established between a first terminal apparatus 10 and a second terminal apparatus 20 that shares electronic money, the first terminal apparatus 10 first performs synchronous processing of matching balance information stored in its own terminal apparatus with balance information stored in the second terminal apparatus 20 and then completes the electronic payment. On the other hand, in a state where pairing is not established between the first terminal apparatus 10 and the second terminal apparatus 20, electronic payment using shared electronic money is prohibited.

With such a known technique, it is possible to suppress the possibility of conducting electronic payment not intended by the user, but at the same time, there is room for improvement in terms of implementing an electronic money function with high usability without causing mutual conflict in payment processing among a plurality of terminal apparatuses.

In view of this, the present disclosure proposes an information processing apparatus, an information processing method, and an information processing program capable of implementing an electronic money function with high usability without causing mutual conflict in payment processing among a plurality of terminal apparatuses.

### Solution to Problem

In order to solve the above problems, one aspect of An information processing apparatus comprising: a management unit configured to manage a balance obtained by totaling electronic money balances held by a plurality of terminal apparatuses each being equipped with an electronic money function, as one balance to be shared among the plurality of terminal apparatuses; and an update unit configured to update balance such that, in a case where electronic payment with the electronic money has been made using one terminal apparatus controlled to be in an electronic payment enabled mode among the plurality of terminal apparatuses, the update unit updates an amount of money obtained by subtracting an amount of used money in the electronic payment from the one balance, as a latest record of the one balance to be shared among the plurality of terminal apparatuses.

### BRIEF DESCRIPTION OF DRAWINGS

FIG. 1 is a diagram illustrating a configuration of a system according to an embodiment.

FIG. 2 is a diagram illustrating a conceptual diagram of an IC chip in a terminal apparatus.

FIG. 3 is a diagram illustrating a configuration example of a terminal apparatus according to the embodiment.

FIG. 4 is a diagram illustrating a configuration example of a balance management apparatus according to the embodiment.

FIG. 5 is a diagram illustrating an example of balance information storage unit according to the embodiment.

FIG. 6 is a sequence diagram illustrating an initial setting procedure regarding balance sharing in a case of first linking terminal apparatuses with each other.

FIG. 7 is a sequence diagram illustrating an additional setting procedure regarding balance sharing in a case of further adding a terminal apparatus to be linked.

FIG. 8 is a diagram illustrating an example of a linkage information storage unit according to the embodiment.

FIG. 9 is a sequence diagram illustrating a linkage canceling procedure.

FIG. 10 is a sequence diagram (1) illustrating a procedure of electronic payment lock control processing.

FIG. 11 is a sequence diagram (1) illustrating a procedure of balance update processing.

FIG. 12 is a sequence diagram (2) illustrating a procedure of the electronic payment lock control processing.

FIG. 13 is a sequence diagram (2) illustrating the procedure of balance update processing.

FIG. 14 is a diagram illustrating an example of a selection screen allowing selection of a validation terminal.

FIG. 15 is a block diagram illustrating a hardware configuration example of a computer corresponding to a balance management apparatus 100 according to the embodiment of the present disclosure.

### DESCRIPTION OF EMBODIMENTS

Embodiments of the present disclosure will be described below in detail with reference to the drawings. The information processing apparatus and the information processing method according to the present disclosure are not limited by the embodiments. Moreover, in the following embodiments, the same parts are denoted by the same reference symbols, and a repetitive description thereof will be omitted.

### Embodiment

### [1. Introduction]

In an existing stored-value electronic money service, a value of electronic money is held on an IC chip of a terminal apparatus. Therefore, a service that can be used in each of a plurality of terminal apparatuses and a value balance of each service are different, and there is no mechanism for sharing the values.

In addition, in the electronic money service based on the balance on the IC chip as a master, in order to implement value sharing among a plurality of terminal apparatuses, it is necessary to constantly synchronize the balance without causing conflict in payment processing, and thus, the value balance sharing is difficult to implement with the known technique.

In addition, in a service (including a server type electronic money using a QR code (registered trademark)) providing a payment means usable by a plurality of terminal apparatuses, there is a need, at every payment, to perform a predetermined procedure or operation for starting an application or a browser and using a value managed by the server, having a problem of complication.

In view of this, the information processing apparatus according to the proposed technology of the present disclosure performs information processing for solving the above problem.

For example, when electronic values are shared among a plurality of terminal apparatuses, the information processing apparatus implements information processing capable of handling various use cases such as selecting some of a plurality of terminal apparatuses daily or performing model change. In addition, in a case where electronic values are shared among a plurality of terminal apparatuses, the information processing apparatus implements information processing capable of achieving avoidance of a conflict due to simultaneous use, as well as convenience including enhanced simplicity and payment speed.

### [2. System Configuration]

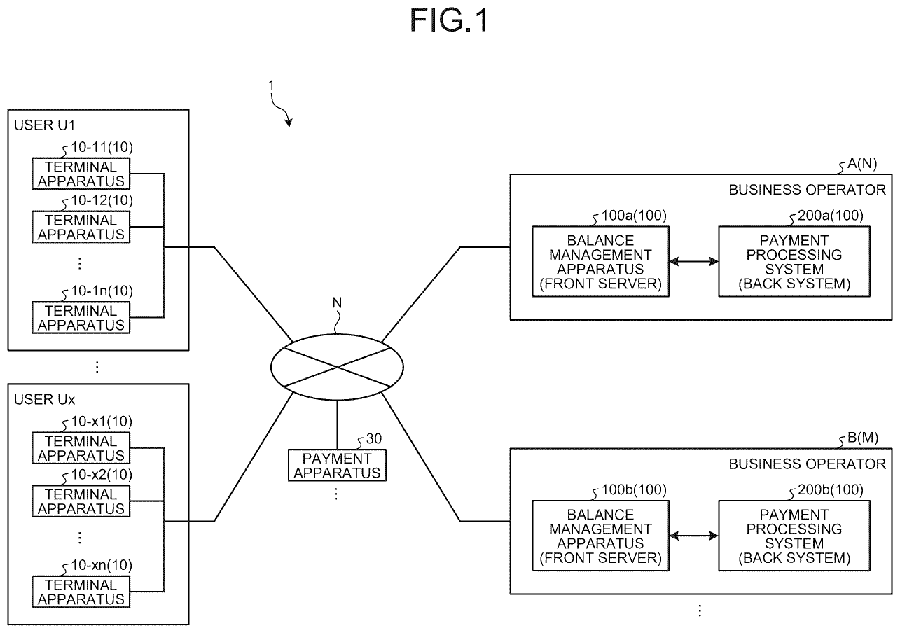

First, a configuration of a system according to the embodiment will be described with reference to FIG. 1. FIG. 1 is a diagram illustrating a configuration of a system according to the embodiment. FIG. 1 illustrates a system 1 as an example of the system according to the embodiment.

As illustrated in FIG. 1, the system 1 may include a terminal apparatus 10, a payment apparatus 30, a balance management apparatus 100, and a payment processing system 200. Furthermore, the terminal apparatus 10, the payment apparatus 30, the balance management apparatus 100, and the payment processing system 200 may be communicably interconnected in a wired or wireless channel via the network N.

The terminal apparatus 10 is an information processing terminal used by a user of electronic money. Examples of the terminal apparatus 10 include a smartphone, a tablet terminal, a laptop personal computer (PC), a desktop PC, a mobile phone, a personal digital assistant (PDA), and a wearable terminal such as a smart watch.

The terminal apparatus 10 is equipped with a near-field wireless communication technology such as Felica (registered trademark). For example, such near-field wireless communication exchanged between the terminal apparatus 10 and the payment apparatus 30 is secure wireless communication at a distance of about several cm using a predetermined encryption key, for example.

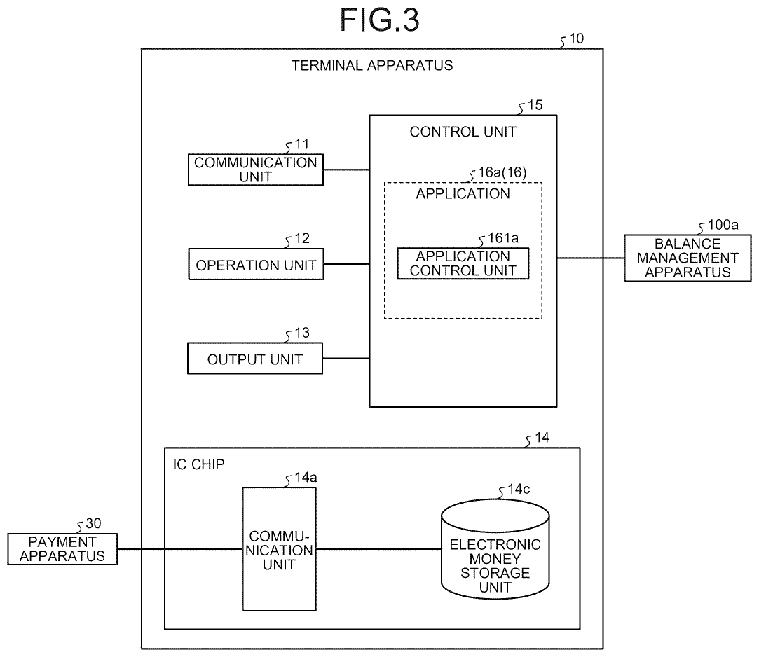

Furthermore, the terminal apparatus 10 has an electronic money function such as payment processing and balance increase/decrease processing by electronic money using an IC chip 14, being a built-in and non-contact chip (refer to FIG. 3). Furthermore, the terminal apparatus 10 may communicate with the balance management apparatus 100. The communication with the balance management apparatus 100 is performed by an application 16 (refer to FIG. 3) which is application software providing various services related to electronic money.

Here, as illustrated in FIG. 1, in the present embodiment, it is assumed that a certain user Ux selectively uses a plurality of terminal apparatuses 10 for different occasions. In this regard, FIG. 1 illustrates an example in which the plurality of terminal apparatuses 10 possessed by the user Ux includes a terminal apparatus 10-x1, a terminal apparatus 10-x2 . . . , a terminal apparatus 10-xn. Furthermore, FIG. 1 illustrates an example in which a user U1 possesses a terminal apparatus 10-11, a terminal apparatus 10-12 . . . , and the terminal apparatus 10-1n, as a specific example of the selective use.

In the following, it is assumed that the user U1 possesses three terminal apparatuses 10, namely the terminal apparatus 10-11, the terminal apparatus 10-12, and the terminal apparatus 10-13 for selective use for each situation. On the other hand, in a case where there is no need to distinguish the terminal apparatus 10-11, the terminal apparatus 10-12, the terminal apparatus 10-13, etc. from each other, the terminal apparatus is simply described as the terminal apparatus 10.

The payment apparatus 30 is a reader/writer installed at locations such as a cashier counter of a real shop, a vending machine, or an automatic ticket gate of a station. The payment apparatus 30 is connectable to the IC chip 14 by near-field wireless communication, and as a result, the user Ux uses electronic payment by bringing (holding) the terminal apparatus 10 close to (over) the payment apparatus 30.

Furthermore, along with near-field wireless communication with the terminal apparatus 10, the payment apparatus 30 can also communicate with the payment processing system 200 via the network N, so as to transmit information such as a payment amount, and relay communication between the payment processing system 200 and the terminal apparatus 10.

Here, FIG. 1 illustrates an example in which a business operator A that operates electronic money N as the electronic money type and a business operator B that operates electronic money M as the electronic money type join in the system 1. In this manner, in a case where a plurality of electronic money businesses joins the system 1, the balance management apparatus 100 and the payment processing system 200 may exist for each business operator.

The balance management apparatus 100 is an example of an information processing apparatus according to the embodiment of the present disclosure. FIG. 1 illustrates an example in which the system 1 is equipped with a balance management apparatus 100a as the balance management apparatus 100 corresponding to the business operator A. Furthermore, FIG. 1 illustrates an example in which the system 1 is equipped with a balance management apparatus 100b as the balance management apparatus 100 corresponding to the business operator B. In a case where it is not necessary to distinguish the apparatuses such as the balance management apparatus 100a and the balance management apparatus 100b, the apparatus will be simply described as the balance management apparatus 100.

The balance management apparatus 100 is an apparatus that executes information processing according to the embodiment, and may be, for example, a cloud computer that performs processing on the cloud for the terminal apparatus 10 corresponding to an edge computer that performs edge processing near the user Ux. That is, the balance management apparatus 100 may be a server apparatus.

The payment processing system 200 is a server that manages the movement of the monetary value using the value of the corresponding electronic money type, and has a role of controlling official payment processing between the right holder (for example, a shop and a transportation company) of the payment apparatus 30 and the user Ux based on a payment log acquired from the payment apparatus 30.

FIG. 1 illustrates an example in which the system 1 is equipped with a payment processing system 200a as the payment processing system 200 corresponding to the business operator A. As illustrated in FIG. 1, the balance management apparatus 100a and the payment processing system 200a has a relationship of a front server and a back system, and are communicably connected to each other.

Furthermore, FIG. 1 illustrates an example in which the system 1 is equipped with a payment processing system 200b as the payment processing system 200 corresponding to the business operator B. As illustrated in FIG. 1, the balance management apparatus 100b and the payment processing system 200b has a relationship of a front server and a back system, and are communicably connected to each other.

In a case where it is not necessary to distinguish the systems, such as the payment processing system 200a and the payment processing system 200b, the system will be simply described as the payment processing system 200.

### [3. Configuration of IC Chip]

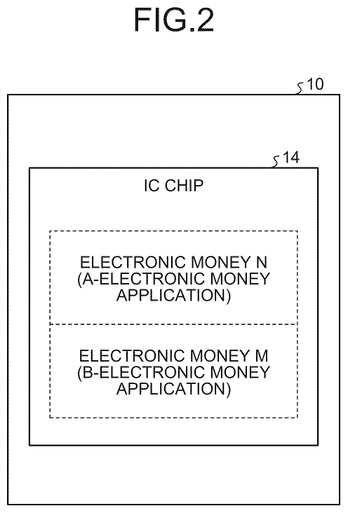

Next, the IC chip 14 built in the terminal apparatus 10 will be described with reference to FIG. 2. FIG. 2 is a diagram illustrating a conceptual diagram of the IC chip 14 in the terminal apparatus 10.

The IC chip 14 is an electronic module including devices such as a central processing unit (CPU), read only memory (ROM), random access memory (RAM), and electrically erasable programmable read only memory (EEPROM), and can be connected to the payment apparatus 30 by near-field wireless communication. Furthermore, the IC chip 14 may be connected to the CPU of the terminal apparatus 10 by a wired channel.

As illustrated in FIG. 2, the IC chip 14 can incorporate (install) an A-electronic money application corresponding to the electronic money N provided by the business operator A and a B-electronic money application corresponding to the electronic money M provided by the business operator B. According to such an example, the terminal apparatus 10 is considered to have a function similar to incorporating an electronic money card of the electronic money N provided by the business operator A and an electronic money card of the electronic money M provided by the business operator B.

The IC chip 14 includes, for example, a storage area in which an A electronic money application is formed and a storage area in which the B-electronic money application is formed. These electronic money applications are executed by a control unit (a functional unit formed by reading an operating system (OS) or an application program operating on the OS into a CPU in a chip) of the IC chip 14.

For example, by installing an application 16a corresponding to the electronic money N among the applications 16 described above on the terminal apparatus 10, the user Ux can form the A-electronic money application in the corresponding storage area. As a result, the terminal apparatus 10 has the function of the electronic money N.

Similarly, by installing an application 16b corresponding to the electronic money M among the applications 16 on the terminal apparatus 10, the user Ux can form the B-electronic money application in the corresponding storage area. As a result, the terminal apparatus 10 has the function of the

### [4. Configuration of Terminal Apparatus]

FIG. 3 is a diagram illustrating a configuration example of the terminal apparatus 10 according to the embodiment. As illustrated in FIG. 3, the terminal apparatus 10 according to the embodiment includes a communication unit 11, an operation unit 12, an output unit 13, an IC chip 14, and a control unit 15.

### (Communication Unit 11)

The communication unit 11 is actualized by a network interface card (NIC), for example. For example, the communication unit 11 is wirelessly connected to the network N, and transmits and receives information to and from the balance management apparatus 100, for example.

### (Operation Unit 12)

The operation unit 12 functions as an input unit that receives various operations of the user Ux. The operation unit 12 receives, from the user Ux, an operation onto the information output by the output unit 13, for example.

### (Output Unit 13)

The output unit 13 may be a display screen actualized by a display such as a liquid crystal display and an organic electro-luminescence (EL) display, for example, and may be a display apparatus for displaying various types of information. The output unit 13 is not limited to the display screen, and may be a speaker that outputs sound, for example.

### (IC Chip 14)

The IC chip 14 has an electronic money function and is connected to the payment apparatus 30 by near-field wireless communication. Note that FIG. 3 illustrates a case where the A-electronic money application is formed on the IC chip 14 by installing the application 16a corresponding to the electronic money N. That is, the IC chip 14 has an electronic money function for electronic money N.

As illustrated in FIG. 3, the IC chip 14 includes a communication unit 14a and an electronic money storage unit 14c.

### (Communication Unit 14a)

When having received a command or the like related to electronic payment from the payment apparatus 30 (reader/writer), the communication unit 14a executes processing according to the received command. For example, the communication unit 14a may control the balance stored in the electronic money storage unit 14c in response to a command (for example, an amount change command) input from the outside.

### (Electronic Money Storage Unit 14c)

The electronic money storage unit 14c stores data such as a value balance and usage log data. In the example of FIG. 3, the electronic money storage unit 14c may store a value balance after recharging of the electronic money N or a value balance after an electronic payment made using the electronic money N.

### (Control Unit 15)

The control unit 15 is implemented by executing various programs stored in a storage device inside the terminal apparatus 10 using the RAM as a work area by the unit such as the CPU and the micro processing unit (MPU). Furthermore, the control unit 15 is actualized by, for example, an integrated circuit such as an application specific integrated circuit (ASIC) or a field programmable gate array (FPGA).

### (Application Control Unit 161a)

An application control unit 161a is formed by the control unit 15 (CPU) executing the application 16a, being application software providing various services related to the electronic money N of the business operator A. When the application 16a is executed, the A-electronic money application is formed in a storage area of the IC chip 14, allowing the IC chip 14 to have a function of the electronic money N.

As illustrated in FIG. 3, the application control unit 161a can access both the balance management apparatus 100a of the business operator A and the IC chip 14. That is, the application control unit 161a can provide a function for the user Ux to operate the terminal apparatus 10 to access the A-electronic money application, and can mediate communication between the balance management apparatus 100a and the IC chip 14.

### [5. Configuration of Balance Management Apparatus]

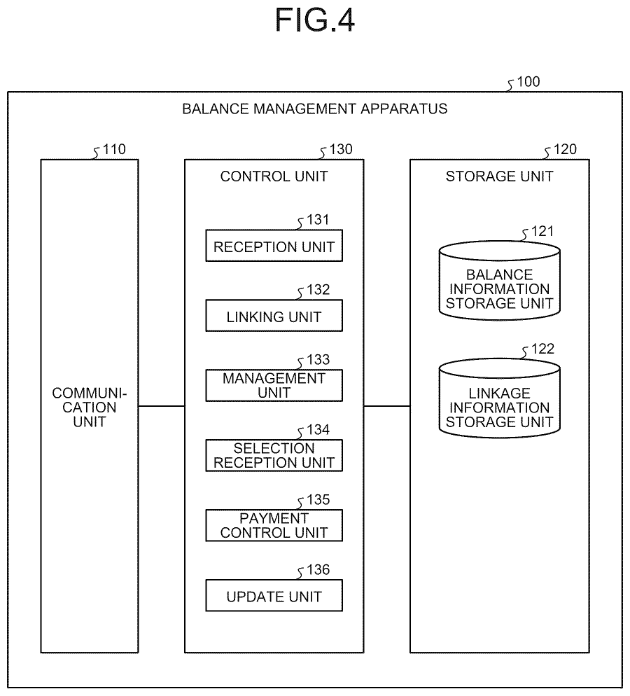

Next, the balance management apparatus 100 according to the embodiment will be described with reference to FIG. 4. FIG. 4 is a diagram illustrating a configuration example of the balance management apparatus 100 according to the embodiment. As illustrated in FIG. 4, the balance management apparatus 100 includes a communication unit 110, a storage unit 120, and a control unit 130.

### (Communication Unit 110)

The communication unit 110 is implemented by a NIC, for example. For example, the communication unit 110 is wirelessly connected to the network N, and transmits and receives information to and from the terminal apparatus 10 and the payment processing system 200, for example.

### (Storage Unit 120)

The storage unit 120 is implemented by a semiconductor memory element such as RAM or flash memory, or a storage device such as a hard disk or an optical disk, for example. The storage unit 120 includes a balance information storage unit 121 and a linkage information storage unit 122.

### (Balance Information Storage Unit 121)

The balance information storage unit 121 stores information regarding a proprietary balance, being an electronic money balance individually held by each terminal apparatus 10 according to the electronic money function installed on the apparatus itself. For example, in a case where linkage processing described below has not been performed, the balance management apparatus 100 can acquire the proprietary balance by making access to the electronic money storage unit 14c of the terminal apparatus 10.

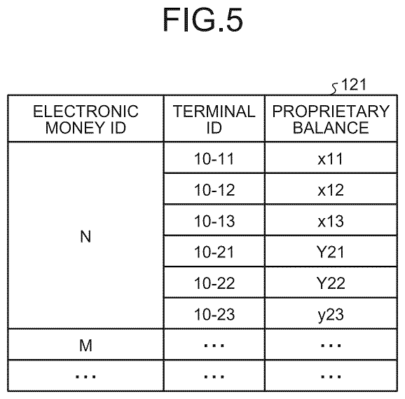

Here, FIG. 5 illustrates an example of the balance information storage unit 121 according to the embodiment. In the example of FIG. 5, the balance information storage unit 121 includes items such as “electronic money ID”, “terminal ID”, and “proprietary balance”.

The “electronic money ID” indicates identification information identifying the electronic money type, that is, the electronic money type of the electronic money function installed in the terminal apparatus 10 identified by the “terminal ID”.

The “terminal ID” indicates identification information identifying the terminal apparatus 10.

The “proprietary balance” is information indicating an electronic money balance (value balance) individually held in accordance with the terminal apparatus 10 identified by the “terminal ID” having the function of electronic money identified by the “electronic money ID”.

FIG. 5 illustrates an example in which an electronic money ID “N”, terminal ID “10-11”, and a proprietary balance “x11” are associated with each other. Such an example illustrates an example in which execution of the application 16a corresponding to the electronic money N of the business operator A allows the terminal apparatus 10 to have an electronic payment function using the electronic money N. That is, this represents an example in which the terminal apparatus 10 has a function similar to incorporating an electronic money card of the electronic money N. Furthermore, such an example represents an example in which “x 11” is held as the value balance of the electronic money N in the electronic money storage unit 14c of the terminal apparatus 10-11.

### (Linkage Information Storage Unit 122)

The linkage information storage unit 122 stores the following in association with each other: “electronic money ID” identifying an electronic money type; “terminal ID” identifying each of a plurality of terminal apparatuses 10 linked with each other using account information; and “one balance” shared among the plurality of terminal apparatuses 10. Details of the linkage information storage unit 122 will be described below.

### (Control Unit 130)

The control unit 130 is implemented by execution of various programs (for example, an information processing program) stored in a storage device inside the balance management apparatus 100 by a unit such as the CPU and the MPU using RAM as a work area. Furthermore, the control unit 130 is implemented by an integrated circuit such as ASIC or FPGA.

As illustrated in FIG. 4, the control unit 130 includes a reception unit 131, a linking unit 132, a management unit 133, a selection reception unit 134, a payment control unit 135, and an update unit 136, and implements or executes a function and an operation of information processing described below. Not limited to the configuration illustrated in FIG. 4, the internal configuration of the control unit 130 may have a different configuration as long as it performs information processing described below. Furthermore, the connection relationship of the processing units included in the control unit 130 is not limited to the connection relationship illustrated in FIG. 4, and may be a different connection

### (Reception Unit 131)

The reception unit 131 receives various types of information from the terminal apparatus 10. For example, when linking the plurality of terminal apparatuses 10 with each other, the reception unit 131 may receive a predetermined request from the terminal apparatus 10 to be linked. For example, the reception unit 131 may receive an initial setting start request or an additional setting start request to be described below. The reception unit 131 may also receive authentication information.

### (Linking Unit 132)

In response to a request from the user Ux, the linking unit 132 performs a series of linkage processing of linking the terminal apparatuses 10 being targets of balance sharing with each other.

### (Management Unit 133)

The management unit 133 manages a balance obtained by combining the electronic money balances held in each of the plurality of terminal apparatuses 10 each having an electronic money function, as a record of one balance to be shared among the plurality of terminal apparatuses 10. For example, in accordance with an operation by the user Ux of the plurality of terminal apparatuses 10, the management unit 133 manages the following linked with each other: electronic money ID identifying electronic money; one balance corresponding to the electronic money; and terminal ID identifying each of the plurality of terminal apparatuses 10.

### (Selection Reception Unit 134)

The selection reception unit 134 receives selection of one terminal apparatus to be validated to enable electronic payment among the plurality of terminal apparatuses 10. For example, the selection reception unit 134 receives selection to switch one terminal apparatus 10 to be validated to enable electronic payment from a current terminal apparatus to another terminal apparatus. In addition, the selection reception unit 134 may further receive an access from one terminal apparatus 10 as a validation target, being a terminal apparatus to be validated according to the selection.

### (Payment Control Unit 135)

The payment control unit 135 controls one terminal apparatus 10 selected as the validation target to be in an electronic payment enabled mode, while controlling the other unselected terminal apparatuses to be in an electronic payment disabled mode. For example, the payment control unit 135 controls the terminal apparatus 10 of the switching destination to be an electronic payment enabled mode, while controlling the terminal apparatus 10 other than the terminal apparatus 10 of the switching destination among the plurality of terminal apparatuses 10 to be in an electronic payment disabled mode.

Furthermore, in a case where access is received from one terminal apparatus 10 as the validation target, the payment control unit 135 determines whether the electronic money balance held by the accessed terminal apparatus 10 has been updated as the latest record of the one balance. The payment control unit 135 controls the terminal apparatus 10 that has made the access to be in the electronic payment enabled mode only in a case where the payment control unit 135 has determined that the electronic money balance has been updated as the latest record of the one balance.

### (Update Unit 136)

In a case where electronic money payment has been made by electronic money using one terminal apparatus 10 controlled to be set in the electronic payment enabled mode among the plurality of terminal apparatuses 10, the update unit 136 updates an amount of money obtained by subtracting an amount of used money in the electronic payment from the one balance, as the latest record of the one balance to be shared among the plurality of terminal apparatuses 10. For example, the update unit 136 provides the amount of money obtained by subtracting the amount of used money from the one balance to one terminal apparatus 10 controlled to be in the electronic payment enabled mode and the other terminal apparatus 10 among the plurality of terminal apparatuses 10, thereby allowing the apparatuses to hold the amount of money as the latest record of the one balance.

[6. Procedure of Balance Sharing by Linking Terminals with Each Other]

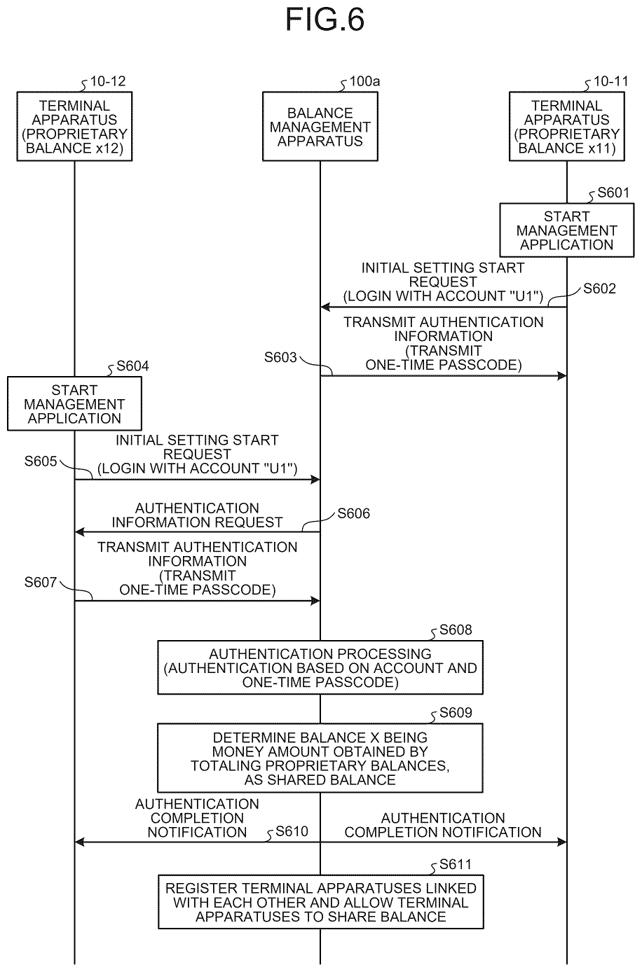

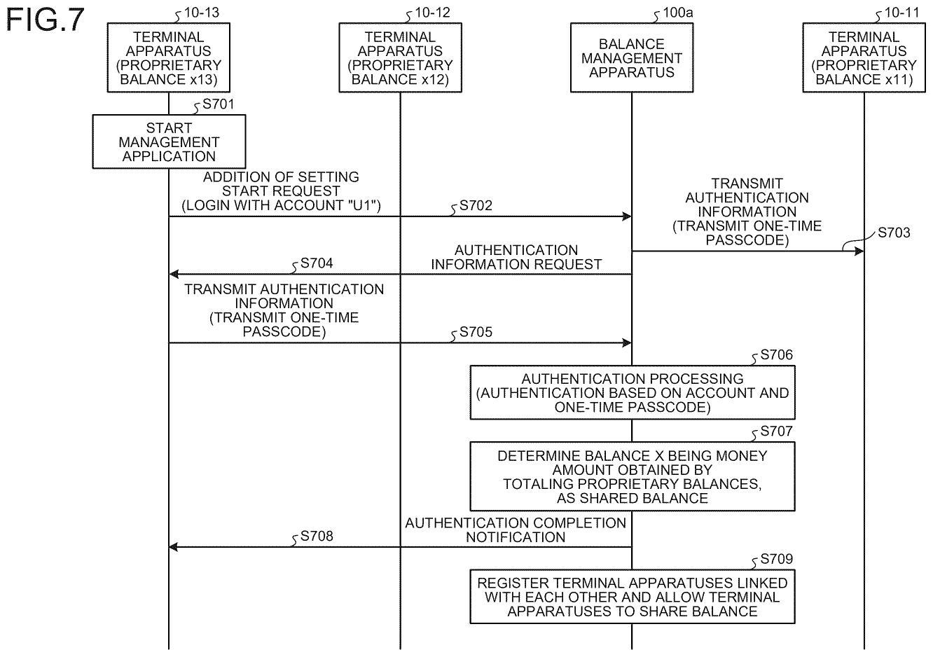

Next, a procedure of balance sharing setting by linking different terminal apparatuses 10 with each other will be described with reference to FIGS. 6 and 7. With FIG. 6, an initial setting procedure in a case where the terminal apparatuses 10 are linked with each other for the first time in balance sharing will be described. On the other hand, with FIG. 7, an additional setting procedure in a case where the terminal apparatus 10 to be linked is added in balance sharing will be described.

Note that FIGS. 6 and 7 illustrate a case where these terminal apparatuses 10 are linked in accordance with an operation by the user U1 who selectively uses three terminal apparatuses 10, that is, the terminal apparatus 10-11, the terminal apparatus 10-12, and the terminal apparatus 10-13. Furthermore, the application 16a corresponding to the electronic money N is installed in the terminal apparatus 10-11, the terminal apparatus 10-12, and the terminal apparatus 10-13, whereby the A-electronic money application is formed in each IC chip 14. That is, the terminal apparatus 10-11, the terminal apparatus 10-12, and the terminal apparatus 10-13 have an electronic money function for the electronic money N.

### [6-1. Initial Setting Procedure]

FIG. 6 is a sequence diagram illustrating an initial setting procedure regarding balance sharing in a case of first linking the terminal apparatuses 10 with each other. FIG. 6 illustrates an initial setting procedure in a case where the terminal apparatus 10-11 holding the proprietary balance “x11” and the terminal apparatus 10-12 holding the proprietary balance “x12” are linked with each other in accordance with the operation of the user U1.

First, the terminal apparatus 10-11 starts a dedicated management application AP corresponding to the IC chip 14 in accordance with the operation of the user U1 (Step S601). The management application AP may be pre-installed in the terminal apparatus 10 equipped with the IC chip 14.

Here, the user U1 performs login operation using one piece of account information (hereinafter, referred to as an account “U1”) registered via the management application AP.

Having received the account “U1” by the login operation, the terminal apparatus 10-11 transmits an initial setting start request including the account “U1” to the balance management apparatus 100a (Step S602).

When an initial setting start request has been received by the reception unit 131, the linking unit 132 of the balance management apparatus 100a transmits authentication information to the terminal apparatus 10-11 (Step S603). For example, the linking unit 132 may transmit a one-time passcode.

After confirming the notification of the authentication information via the terminal apparatus 10-11, the user U1 next operates the terminal apparatus 10-12. The terminal apparatus 10-12 starts the management application AP in accordance with the operation of the user U1 (Step S604).

The user U1 performs login operation using a similar account “U1”. Having received the account “U1” by the login operation, the terminal apparatus 10-12 transmits an initial setting start request including the account “U1” to the balance management apparatus 100a (Step S605).

When the initial setting start request has been received by the reception unit 131, the linking unit 132 of the balance management apparatus 100a requests the terminal apparatus 10-12 to input authentication information (Step S606).

When confirming the authentication request via the terminal apparatus 10-12, the user U1 inputs the authentication information (one-time passcode) notified to the terminal apparatus 10-11 to the terminal apparatus 10-12. For example, the user U1 inputs the authentication information to the terminal apparatus 10-12 via the management application AP.

Having received the authentication information, the terminal apparatus 10-12 transmits the authentication information to the balance management apparatus 100a (Step S607).

When the authentication information has been received by the reception unit 131, the linking unit 132 of the balance management apparatus 100a performs authentication processing of confirming the identity of the user U1 between the transmission-side terminal apparatus 10 (that is, the terminal apparatus 10-11) that has transmitted the authentication information and the reception-side terminal apparatus 10 (that is, the terminal apparatus 10-12) that has received the authentication information, based on the account “U1” and the one-time passcode (Step S608). That is, the linking unit 132 performs authentication processing of confirming whether the user Ux of the terminal apparatus 10-11 and the user Ux of the terminal apparatus 10-12 are the same person corresponding to the account “U1”.

In a case where the authentication fails, the linking unit 132 may prohibit the balance sharing without proceeding to Step S609 and end the processing at this point.

In contrast, in a case where the authentication has been successful, the linking unit 132 determines a balance X (that is, x11+x12), which is an amount obtained by totaling the proprietary balance x11 held by the terminal apparatus 10-11 and the proprietary balance x12 held by the terminal apparatus 10-12, as the shared balance (Step S609).

Furthermore, after the shared balance is successfully set, the linking unit 132 may notify the terminal apparatus 10-11 and the terminal apparatus 10-12 of completion of the authentication (Step S610).

Next, the management unit 133 of the balance management apparatus 100a registers the mutual terminal apparatuses 10 linked with each other in the linkage information storage unit 122, so as to allow sharing of the balance X (Step S611). For example, the management unit 133 links the terminal apparatus 10-11 and the terminal apparatus 10-12 with each other using the account “U1”, and manages the shared balance X in association with a set of the terminal apparatus 10-11 and the terminal apparatus 10-12.

### [6-2. Additional Setting Procedure]

FIG. 7 is a sequence diagram illustrating an additional setting procedure regarding balance sharing in a case of further adding the terminal apparatus 10 to be linked. FIG. 7 illustrates an additional setting procedure in a case where the terminal apparatus 10-13 holding a proprietary balance “x13” is further added in a state where the linkage between the terminal apparatus 10-11 and the terminal apparatus 10-12 is completed by the initial setting procedure of FIG. 6.

First, the terminal apparatus 10-13 starts a dedicated management application AP corresponding to the IC chip 14 in accordance with the operation of the user U1 (Step S701).

The user U1 performs login operation using the account “U1” similar to previous operations. Having received the account “U1” by the login operation, the terminal apparatus 10-13 transmits an additional setting start request including the account “U1” to the balance management apparatus 100a (Step S702).

When the additional setting start request has been received by the reception unit 131, the linking unit 132 of the balance management apparatus 100a transmits authentication information to the terminal apparatus 10-11 (Step S703). For example, the linking unit 132 may transmit a one-time passcode. Furthermore, the linking unit 132 of the balance management apparatus 100a requests the terminal apparatus 10-13 to input authentication information (Step S704).

When confirming the authentication request via the terminal apparatus 10-13, the user U1 inputs the authentication information (one-time passcode) notified to the terminal apparatus 10-11 side to the terminal apparatus 10-13. For example, the user U1 inputs the authentication information to the terminal apparatus 10-13 via the management application AP.

Having received the authentication information, the terminal apparatus 10-13 transmits the authentication information to the balance management apparatus 100a (Step S705).

When the authentication information has been received by the reception unit 131, the linking unit 132 of the balance management apparatus 100a performs authentication processing of confirming the identity of the user U1 between the transmission-side terminal apparatus 10 (that is, the terminal apparatus 10-11) that has transmitted the authentication information and the reception-side terminal apparatus 10 (that is, the terminal apparatus 10-13) that has received the authentication information, based on the account “U1” and the one-time passcode (Step S706). That is, the linking unit 132 performs authentication processing of confirming whether the user Ux of the terminal apparatus 10-11 and the user Ux of the terminal apparatus 10-13 are the same person corresponding to the account “U1”.

In a case where the authentication fails, the linking unit 132 may prohibit the balance sharing without proceeding to Step S707 and end the processing at this point.

In contrast, in a case where the authentication has been successful, the linking unit 132 determines a balance X (that is, x11+x12+x13), which is an amount obtained by totaling the proprietary balance x11 held by the terminal apparatus 10-11, the proprietary balance x12 held by the terminal apparatus 10-12, and the proprietary balance x13 held by the terminal apparatus 10-13, as the shared balance (Step S707).

Furthermore, after the shared balance is successfully set, the linking unit 132 may notify the terminal apparatus 10-13 of completion of the authentication (Step S708).

Next, the management unit 133 of the balance management apparatus 100a registers the additional terminal apparatus 10 linked with each other in the linkage information storage unit 122, to allow sharing of the balance X (Step S709). For example, the management unit 133 further links the terminal apparatus 10-13 using the account “U1”, and manages the shared balance X in association with a set of the terminal apparatus 10-11, the terminal apparatus 10-12, and the terminal apparatus 10-13.

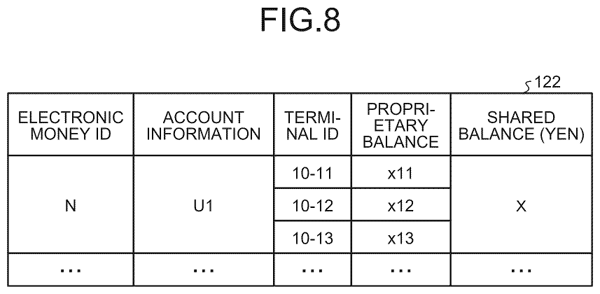

According to the procedures described with reference to FIGS. 6 and 7, the linkage information storage unit 122 of the balance management apparatus 100a has stored, at this point, information in a mode illustrated in FIG. 8. FIG. 8 is a diagram illustrating an example of the linkage information storage unit 122 according to the embodiment.

According to the example of FIG. 8, the terminal apparatuses 10-11, 10-12, and 10-13 are linked with each other by the account “U1” which is one piece of account information registered by the user U1. Furthermore, according to the example of FIG. 8, the balances x11, x12, and x13 of the electronic money N individually held by the terminal apparatuses 10 are totaled, and the total balance X is managed as a shared balance to be shared among the terminal apparatuses 10.

Note that, according to the procedure described with reference to FIGS. 6 and 7, each terminal apparatus 10 may hold the electronic money ID identifying the electronic money N and the terminal ID of the linked terminal apparatus 10 in association with each other in the IC chip 14.

For example, the application control unit 161a of the terminal apparatus 10-11 may register the electronic money ID “N” identifying the electronic money N in the electronic money storage unit 14c of the terminal apparatus 10-11 in a state where the terminal ID “10-12” identifying the terminal apparatus 10-12 and the terminal ID “10-13” identifying the terminal apparatus 10-13 are associated with each other.

Furthermore, the application control unit 161a of the terminal apparatus 10-12 may register the electronic money ID “N” identifying the electronic money N in the electronic money storage unit 14c of the application control unit in a state where the terminal ID “10-11” identifying the terminal apparatus 10-11 and the terminal ID “10-13” identifying the terminal apparatus 10-13 are associated with each other.

Furthermore, the application control unit 161a of the terminal apparatus 10-13 may register the electronic money ID “N” identifying the electronic money N in the electronic money storage unit 14c of the application control unit in a state where the terminal ID “10-11” identifying the terminal apparatus 10-11 and the terminal ID “10-12” identifying the terminal apparatus 10-12 are associated with each other.

With the above processing, each terminal apparatus 10 can recognize which terminal apparatus 10, other than the own apparatus, shares the balance X of the electronic money N.

### [7. Procedure for Deleting Linked Terminal Apparatus]

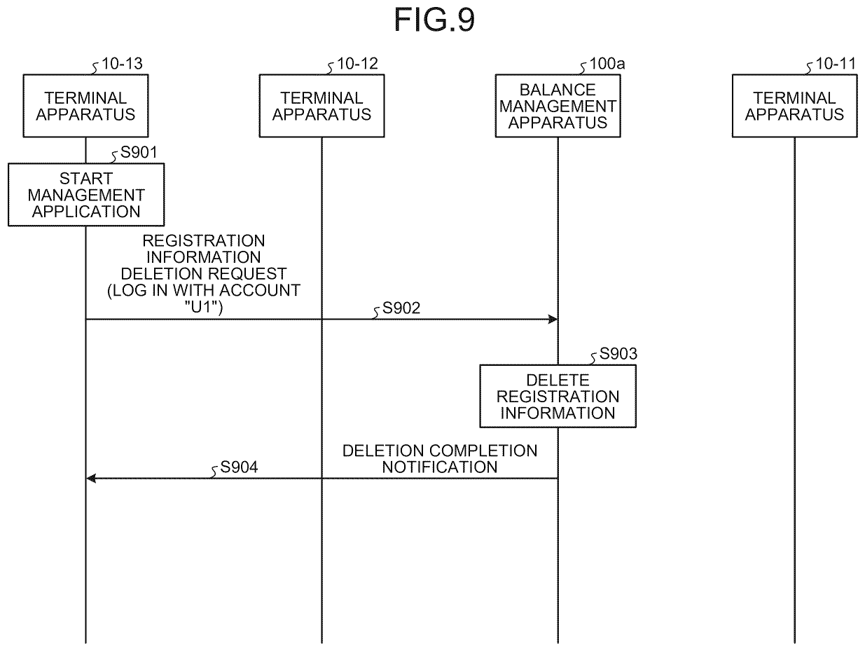

FIGS. 6 and 7 have described the procedure, in order to achieve sharing of the balance, of pre-linking the terminal apparatuses 10 to be allowed to share the balance with each other. FIG. 9 will describe a procedure for canceling linkage (deleting from the linkage) of a certain apparatus among the linked terminal apparatuses 10. FIG. 9 is a sequence diagram illustrating the linkage canceling procedure. FIG. 9 illustrates a case where the terminal apparatus 10-13, among the three terminal apparatuses 10 linked by the procedures of FIGS. 6 and 7, is deleted in accordance with the operation of the user U1.

First, the terminal apparatus 10-13 starts the management application AP in accordance with the operation of the user U1 (Step S901).

The user U1 performs login operation using the account “U1” similar to previous operations. Having received the account “U1” by the login operation, the terminal apparatus 10-13 transmits a registration information deletion request including the account “U1” to the balance management apparatus 100a (Step S902).

When the registration information deletion request has been received by the reception unit 131, the management unit 133 of the balance management apparatus 100a makes access to the linkage information storage unit 122 and deletes the registration information corresponding to the terminal apparatus 10-13 (Step S903). At the current point, the linkage information storage unit 122 has the terminal ID identifying the terminal apparatus 10-11, the terminal ID identifying the terminal apparatus 10-12, and the terminal ID identifying the terminal apparatus 10-13 being linked with each other. The management unit 133 deletes the terminal ID identifying the terminal apparatus 10-13 among these.

Furthermore, the management unit 133 may notify the terminal apparatus 10-13 of completion of deletion (Step S904).

Here, each terminal apparatus 10 may delete card information corresponding to the terminal apparatus 10-13 from the IC chip 14 (electronic money storage unit 14c) along with linkage cancelation of the terminal apparatus 10-13.

For example, the application control unit 161a of the terminal apparatus 10-11 may delete the terminal ID “10-13” linked with the electronic money ID “N” identifying the electronic money N. For example, the application control unit 161a of the terminal apparatus 10-12 may delete the terminal ID “10-13” linked with the electronic money ID “N” identifying the electronic money N.

On the other hand, the terminal apparatus 10-13 may delete the terminal ID “10-11” and the terminal ID “10-12” linked with the electronic money ID “N” identifying the electronic money N.

The above processing cancels a state where the electronic money ID “N” associated with the terminal ID “10-13” exists between the terminal apparatuses 10 that are not linked with each other, making it possible, for example, to prevent an unauthorized use in which the balance X is misused by the terminal apparatus 10-13.

### [8. Processing Procedure Related to Balance Update (1)]

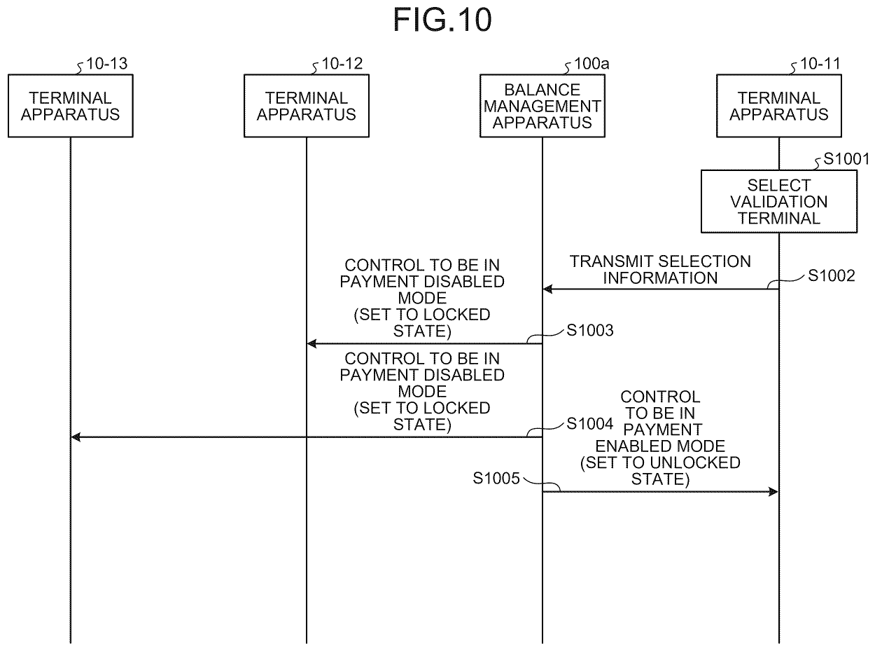

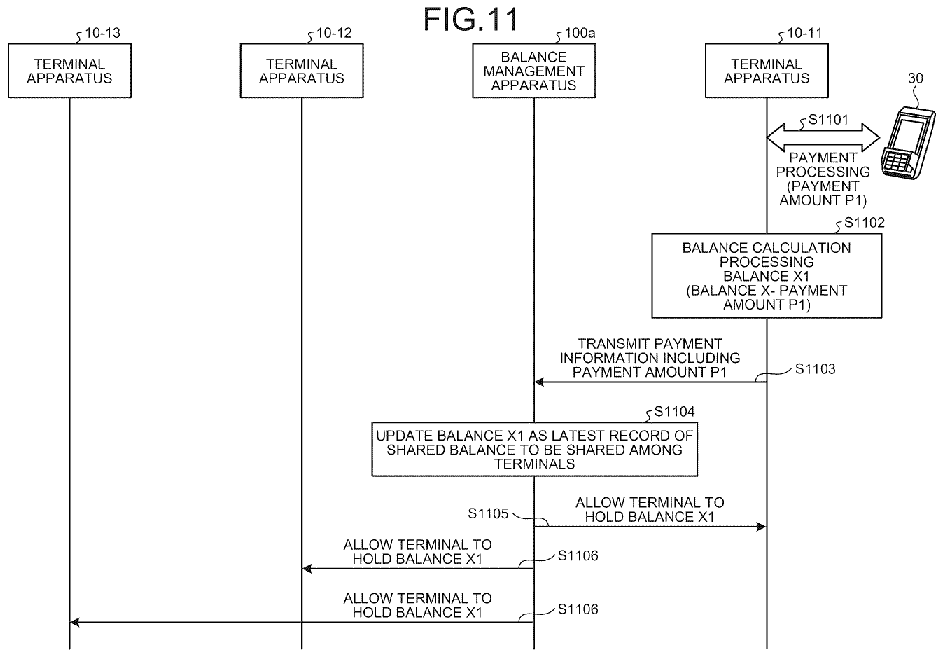

Next, a procedure of balance update processing by the balance management apparatus 100a will be described with reference to FIGS. 10 and 11. FIG. 10 will describe a procedure of electronic payment lock control processing performed as preprocessing of the balance update processing. FIG. 11 will describe a procedure of balance update processing performed in accordance with the electronic payment lock control processing.

### [8-1. Electronic Payment Lock Control Processing]

FIG. 10 is a sequence diagram (1) illustrating a procedure of electronic payment lock control processing. FIG. 10 illustrates a scene in which electronic payment is made for the first time using the terminal apparatus 10-11 after linking has been established among the terminal apparatus 10-11, the terminal apparatus 10-12, and the terminal apparatus 10-13.

According to the example of FIG. 10, for example, the user U1 selects the terminal apparatus 10-11, among the terminal apparatus 10-11, the terminal apparatus 10-12, and the terminal apparatus 10-13, via the management application AP, as a validation terminal, being a terminal to be validated to enable electronic payment with the electronic money N (Step S1001).

In such a case, in accordance with the selection of the self apparatus, namely, the terminal apparatus 10-11, as the validation terminal, the application control unit 161a of the terminal apparatus 10-11 transmits the selection information (for example, information designating the terminal apparatus 10-11 as a validation terminal) to the balance management apparatus 100a (Step S1002). In such an example, the selection reception unit 134 of the balance management apparatus 100a receives the selection of the terminal apparatus 10-11 as the validation terminal, being a terminal to be validated to enable electronic payment with the electronic money N.

Based on the information received by the selection reception unit 134, the payment control unit 135 of the balance management apparatus 100a controls the terminal apparatus 10-12 and the terminal apparatus 10-13 to be in a mode disabling electronic payment with the electronic money N (Steps S1003 and S1004). In such a case, in accordance with control from the payment control unit 135, for example, the application control unit 161a of the terminal apparatus 10-12 controls access to the function of the electronic money N (the A-electronic money application) in the IC chip 14. For example, the application control unit 161a controls to set the electronic money N in the IC chip 14 to a locked state to disable use of the electronic money N. Similarly, the application control unit 161a of the terminal apparatus 10-13 controls to set the electronic money N in the IC chip 14 to a locked state to disable use of the electronic money N.

On the other hand, the payment control unit 135 controls the terminal apparatus 10-11 to be in a state enabling electronic payment with the electronic money N based on the information received by the selection reception unit 134 (Step S1005). In such a case, in accordance with control from the payment control unit 135, for example, the application control unit 161a of the terminal apparatus 10-11 controls access to the function of the electronic money N (the A-electronic money application) in the IC chip 14. For example, the application control unit 161a controls to set the electronic money N in the IC chip 14 to an unlocked state to enable use of the electronic money N.

### [8-2. Balance Update Processing]

Next, balance update processing implemented in accordance with the electronic payment lock control processing of FIG. 10 will be described. FIG. 11 is a sequence diagram (1) illustrating a procedure of balance update processing.

As a result of the electronic payment lock control processing of FIG. 10, the user U1 can perform electronic payment with the electronic money N only on the terminal apparatus 10-11. As illustrated in FIG. 11, it is assumed that the user U1 holds the terminal apparatus 10-11 over the payment apparatus 30 installed in a shop where purchase is to be performed. In such a case, the communication unit 14a of the IC chip 14 and the payment apparatus 30 are connected with each other via near-field wireless communication, and the payment processing according to the payment amount P1 is executed (Step S1101).

Furthermore, the application control unit 161a of the terminal apparatus 10-11 executes balance calculation processing (Step S1102). For example, the application control unit 161a subtracts a payment amount P1 from the current balance X shared among the terminal apparatus 10-11, the terminal apparatus 10-12, and the terminal apparatus 10-13 so as to calculate a balance X1. Note that the balance calculation processing may be performed on the balance management apparatus 100a.

Subsequently, the application control unit 161a transmits the payment information including the payment amount Pl to the balance management apparatus 100a by tap interaction (Step S1103). Note that the payment information may also include the balance X1. On the other hand, in a case where the balance calculation processing is performed on the balance management apparatus 100a, the balance X1 is not included in the payment information.

The update unit 136 of the balance management apparatus 100a updates the balance X1 as a result of subtracting the payment amount P1 from the balance X in the current payment processing, as the latest record of the shared balance to be shared among the terminal apparatuses 10 (Step S1104). For example, the update unit 136 updates the balance X registered as the shared balance to the balance X1 in the linkage information storage unit 122.

Furthermore, the update unit 136 transmits information indicating the balance X1 to the terminal apparatus 10-11 to allow the apparatus to hold the balance X1 as the latest record of the shared balance (Step S1105). In such a case, for example, the application control unit 161a of the terminal apparatus 10-11 controls the electronic money storage unit 14c to store the balance X1.

Furthermore, the update unit 136 also transmits information indicating the balance X1 to the terminal apparatuses 10-12 and 10-13 to allow the apparatuses to hold the balance X1 as the latest record of the shared balance (Step S1106). In such a case, each of the application control unit 161a of the terminal apparatus 10-12 and the application control unit 161a of the terminal apparatus 10-13 individually controls the electronic money storage unit 14c of each own apparatus to store the balance X1.

### [9. Processing Procedure Related to Balance Update (2)]

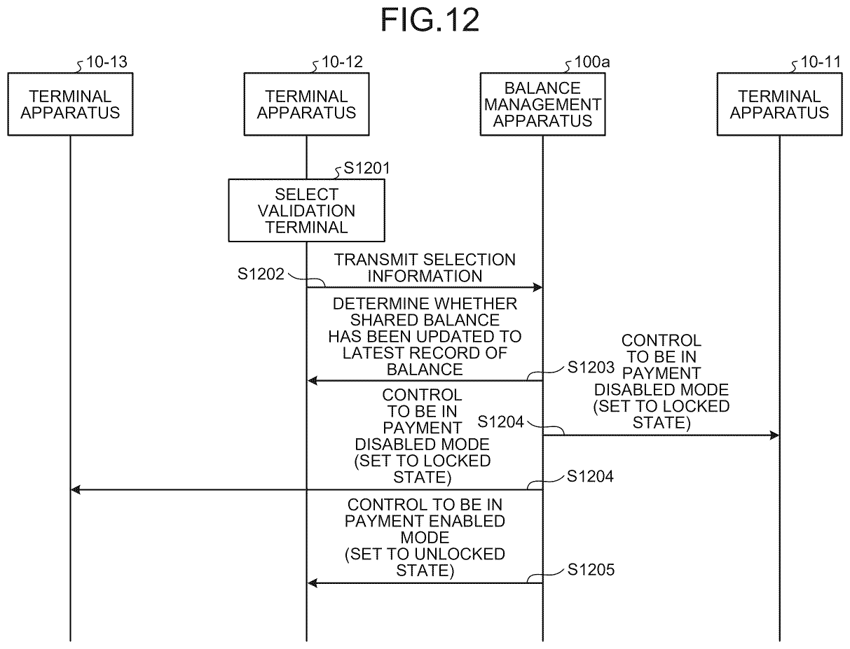

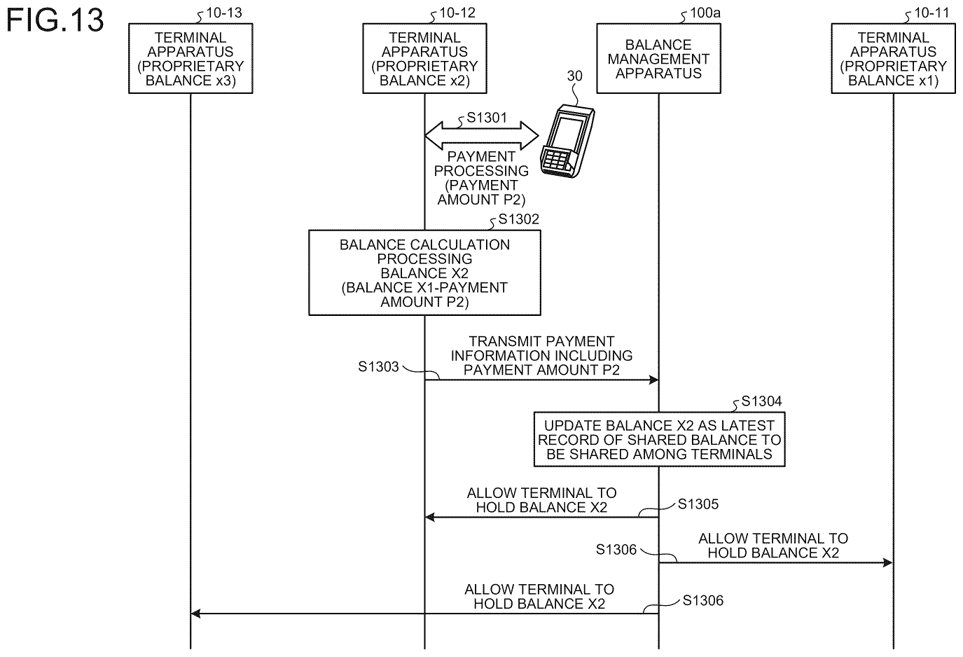

A procedure of balance update processing by the balance management apparatus 100a will be described with reference to FIGS. 12 and 13. FIG. 12 will describe a procedure of the electronic payment lock control processing accompanying the switching of the validation terminal. FIG. 13 will describe a procedure of balance update processing performed in accordance with the electronic payment lock control processing.

### [9-1. Electronic Payment Lock Control Processing]

FIG. 12 is a sequence diagram (2) illustrating a procedure of the electronic payment lock control processing. FIG. 12 illustrates a scene in which the validation terminal, being a terminal to be validated to enable electronic payment with the electronic money N, is switched from the terminal apparatus 10-11 to the terminal apparatus 10-12.

According to the example of FIG. 11, in order to change the validation terminal, being a terminal to be validated to enable electronic payment with the electronic money N, from the terminal apparatus 10-11 to the terminal apparatus 10-12, the user U1 reselects the terminal apparatus 10-12 (Step S1201).

In such a case, in accordance with the selection of the self apparatus, namely, the terminal apparatus 10-12, as the validation terminal, the application control unit 161a of the terminal apparatus 10-12 transmits the selection information (for example, information designating the terminal apparatus 10-12 as a validation terminal) to the balance management apparatus 100a (Step S1202). In such an example, the selection reception unit 134 of the balance management apparatus 100a receives the selection of the terminal apparatus 10-12 as the validation terminal, being a terminal to be validated to enable electronic payment with the electronic money N.

Based on the information received by the selection reception unit 134, the payment control unit 135 of the balance management apparatus 100a determines whether the balance of the electronic money N held by the terminal apparatus 10-12 has been updated to the latest record of the shared balance (Step S1203). For example, the payment control unit 135 may determine the update status based on consistency between the shared balance stored in the linkage information storage unit 122 and the shared balance held by the terminal apparatus 10-12 in the electronic money storage unit 14c.

According to the above example, at the current point, the balance X1 is stored as the shared balance in the linkage information storage unit 122, and the balance X1 is also stored as the shared balance in the electronic money storage unit 14c of the terminal apparatus 10-12. In such a case, the payment control unit 135 can determine that the balance of the electronic money N held by the terminal apparatus 10-12 has been updated to the latest record of the shared balance.

In this manner, the payment control unit 135 executes processing of controlling the terminal apparatus 10-12 to a state enabling electronic payment with the electronic money N only when it can be determined that the balance of the electronic money N held by the terminal apparatus 10-12 has been updated to the latest record of the shared balance.

Based on the information received by the selection reception unit 134, the payment control unit 135 controls the terminal apparatus 10-11 and the terminal apparatus 10-13 to be in a mode disabling electronic payment with the electronic money N (Step S1204). In such a case, in accordance with control from the payment control unit 135, for example, the application control unit 161a of the terminal apparatus 10-11 controls access to the function of the electronic money N (the A-electronic money application) in the IC chip 14. For example, the application control unit 161a controls to set the electronic money N in the IC chip 14 to a locked state to disable use of the electronic money N. Similarly, the application control unit 161a of the terminal apparatus 10-13 controls to set the electronic money N in the IC chip 14 to a locked state to disable use of the electronic money N.

Next, the payment control unit 135 controls the terminal apparatus 10-12 so as to enable electronic payment with the electronic money N (Step S1205). In such a case, in accordance with control from the payment control unit 135, for example, the application control unit 161a of the terminal apparatus 10-12 controls access to the function of the electronic money N (the A-electronic money application) in the IC chip 14. For example, the application control unit 161a controls to set the electronic money N in the IC chip 14 to an unlocked state to enable use of the electronic money N.

### [9-2. Balance Update Processing]

Next, balance update processing implemented in accordance with the electronic payment lock control processing of FIG. 12 will be described. FIG. 13 is a sequence diagram (2) illustrating a procedure of balance update processing.

As a result of the electronic payment lock control processing of FIG. 12, the user U1 can perform electronic payment with the electronic money N only on the terminal apparatus 10-12. As illustrated in FIG. 13, it is assumed that the user U1 holds the terminal apparatus 10-12 over the payment apparatus 30 installed in a shop where purchase is to be performed. In such a case, using touch interaction, the communication unit 14a of the IC chip 14 and the payment apparatus 30 are connected with each other by near-field wireless communication, and the payment processing according to the payment amount P2 is executed (Step S1301).

Furthermore, the application control unit 161a of the terminal apparatus 10-12 executes balance calculation processing (Step S1302). For example, the application control unit 161a subtracting a payment amount P2 from the current balance X1 shared among the terminal apparatus 10-11, the terminal apparatus 10-12, and the terminal apparatus 10-13 so as to calculate a balance X2. Similarly to the above example, the balance calculation processing may be performed on the balance management apparatus 100a.

Subsequently, the application control unit 161a transmits the payment information including the payment amount P2 to the balance management apparatus 100a (Step S1303). Note that the payment information may also include the balance X2. On the other hand, in a case where the balance calculation processing is performed on the balance management apparatus 100a, the balance X2 is not included in the payment information.

The update unit 136 of the balance management apparatus 100a updates the balance X2 as a result of subtracting the payment amount P2 from the balance X1 in the current payment processing, as the latest record of the shared balance to be shared among the terminal apparatuses 10 (Step S1304). For example, the update unit 136 updates the balance X1 registered as the shared balance to the balance X2 in the linkage information storage unit 122.

Furthermore, the update unit 136 transmits information indicating the balance X2 to the terminal apparatus 10-12 to allow the apparatus to hold the balance X2 as the latest record of the shared balance (Step S1305). In such a case, for example, the application control unit 161a of the terminal apparatus 10-11 controls the electronic money storage unit 14c to store the balance X2. At this point, the balance X1 stored in the electronic money storage unit 14c is overwritten with the balance X2.

Furthermore, the update unit 136 also transmits information indicating the balance X1 to the terminal apparatuses 10-11 and 10-13 to allow the apparatuses to hold the balance X2 as the latest record of the shared balance (Step S1306). In such a case, each of the application control unit 161a of the terminal apparatus 10-11 and the application control unit 161a of the terminal apparatus 10-13 controls the electronic money storage unit 14c of each own device to store the balance X2.

### [10. Validation Terminal Selection Screen]

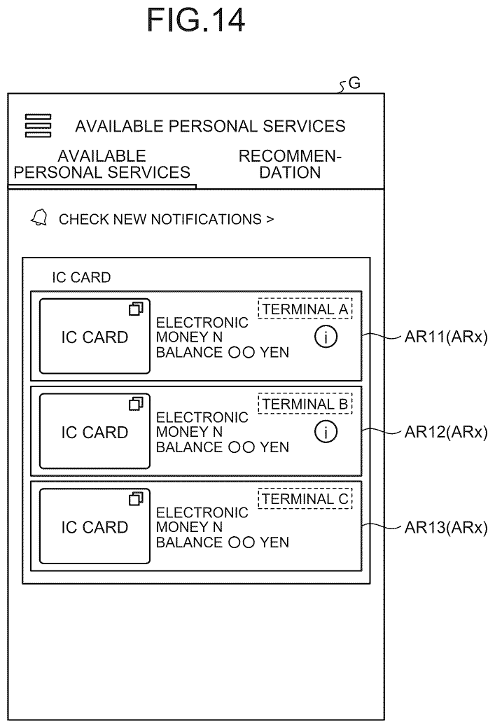

The selection of the validation terminal has been described with reference to FIGS. 10 and 12. For example, the user Ux can select a validation terminal on a selection screen as illustrated in FIG. 14. FIG. 14 is a diagram illustrating an example of a selection screen allowing selection of a validation terminal. A selection screen G illustrated in FIG. 14 may be one screen implemented by the management application AP, for example.

On the selection screen G, the balance currently shared among the terminal apparatuses 10 may be displayed for each type of the electronic money application (each type of electronic money) commonly installed in each of the linked terminal apparatuses 10 including the own apparatus. Furthermore, the selection screen G may include a selection area ARx corresponding to each of the terminal apparatuses 10 so that any one of the linked terminal apparatuses 10 can be selected as the validation terminal.

The selection screen G illustrated in FIG. 14 corresponds to an example of a case where the terminal apparatus 10-11, the terminal apparatus 10-12, and the terminal apparatus 10-13 are linked with each other. The selection screen G includes: an area AR11 controlled to be able to select the terminal apparatus 10-11 as the validation terminal; an area AR12 controlled to be able to select the terminal apparatus 10-12 as the validation terminal; and an area AR13 controlled to be able to select the terminal apparatus 10-13 as the validation terminal.

For example, in the example of FIG. 10, the user U1 selects the area AR11 using the selection screen G to designate the terminal apparatus 10-11 as the validation terminal. In the example of FIG. 12, the user U1 similarly uses the selection screen G to select the area AR11, thereby changing the validation terminal from the terminal apparatus 10-11 to the terminal apparatus 10-12.

As illustrated in FIG. 14, the name (for example, terminal A) of the terminal apparatus 10-11 may be displayed in the area AR11 so that the user can easily visually recognize that the area AR11 is an operation target for validating the terminal apparatus 10-11.

Furthermore, the name (for example, terminal B) of the terminal apparatus 10-12 may be displayed in the area AR12 so that the user can easily visually recognize that the area AR12 is an operation target for validating the terminal apparatus 10-12.

Similarly, the name (for example, terminal C) of the terminal apparatus 10-13 may be displayed in the area AR13 so that the user can easily visually recognize that the area AR13 is the operation target for validating the terminal apparatus 10-13.

In addition, the name of each terminal apparatus 10 may be pre-registered by the user.

### [11. Effects]

The balance management apparatus 100 according to the embodiment of the present disclosure has been described in detail with reference to the drawings. With such a balance management apparatus 100, for example, it is not necessary for a shop joining an existing electronic money service to refurbish an infrastructure such as a payment apparatus, making it possible to continuously utilize the convenience of existing electronic money.

Furthermore, since the record of the electronic money balance is shared among the plurality of terminal apparatuses 10 via the balance management apparatus 100, the user Ux can seamlessly continue to use electronic money even in situations such as model change of the terminal apparatus 10.

In terms of the above point, the balance management apparatus 100 makes it possible to implement an electronic money service with high usability.

### [12. Hardware Configuration]

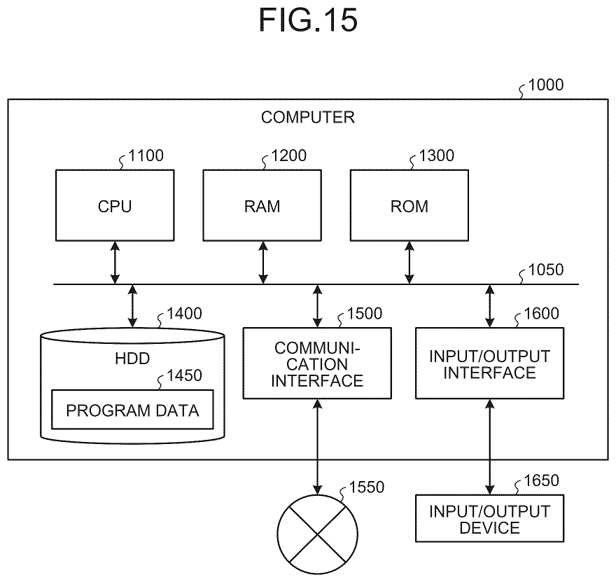

A hardware configuration example of a computer corresponding to the balance management apparatus 100 (information processing apparatus) according to the above-described embodiment will be described with reference to FIG. 15. FIG. 15 is a block diagram illustrating a hardware configuration example of a computer corresponding to a balance management apparatus 100 according to the embodiment of the present disclosure. Note that FIG. 15 illustrates an example of a hardware configuration of a computer corresponding to the balance management apparatus 100 according to the embodiment of the present disclosure, and the configuration is not to be necessarily limited to the configuration illustrated in FIG. 15.

As illustrated in FIG. 15, a computer 1000 includes a central processing unit (CPU) 1100, random access memory (RAM) 1200, read only memory (ROM) 1300, a hard disk drive (HDD) 1400, a communication interface 1500, and an input/output interface 1600. Individual components of the computer 1000 are interconnected by a bus 1050.

The CPU 1100 operates based on a program stored in the ROM 1300 or the HDD 1400 so as to control each of components. For example, the CPU 1100 develops a program stored in the ROM 1300 or the HDD 1400 onto the RAM 1200, and executes processing corresponding to various programs.

The ROM 1300 stores a boot program such as a basic input output system (BIOS) executed by the CPU 1100 when the computer 1000 starts up, a program dependent on hardware of the computer 1000, or the like.

The HDD 1400 is a non-transitory computer-readable recording medium that records a program executed by the CPU 1100, data used by the program, or the like. Specifically, the HDD 1400 records program data 1450. The program data 1450 is an example of an information processing program for implementing the information processing method according to the embodiment of the present disclosure and an example of data used by the information processing program.

The communication interface 1500 is an interface for connecting the computer 1000 to an external network 1550 (for example, the Internet). For example, the CPU 1100 receives data from other devices or transmits data generated by the CPU 1100 to other devices via the communication interface 1500.

The input/output interface 1600 is an interface for connecting an input/output device 1650 with the computer 1000. For example, the CPU 1100 receives data from an input device such as a keyboard or a mouse via the input/output interface 1600. In addition, the CPU 1100 transmits data to an output device such as a display apparatus, a speaker, or a printer via the input/output interface 1600. Furthermore, the input/output interface 1600 may function as a media interface for reading a program or the like recorded on a predetermined recording medium. Examples of the media include optical recording media such as a digital versatile disc (DVD) or a phase change rewritable disk (PD), a magneto-optical recording medium such as a magneto-optical disk (MO), a tape medium, a magnetic recording medium, and semiconductor memory.

For example, when the computer 1000 functions as the balance management apparatus 100 according to the embodiment of the present disclosure, the CPU 1100 of the computer 1000 executes the information processing program loaded on the RAM 1200 so as to implement various types of functions executed by each portion of the control unit 130 illustrated in FIG. 4. That is, the devices such as the CPU 1100 and the RAM 1200 implement the information processing method by the balance management apparatus 100 according to the embodiment of the present disclosure in cooperation with software (information processing program loaded on the RAM 1200).

### [13. Summary]

The embodiments of the present disclosure have been described above. However, the technical scope of the present disclosure is not limited to the above-described embodiments, and various modifications can be made without departing from the scope of the present disclosure. Moreover, it is also allowable to combine the components across the embodiments and modifications as appropriate.

The effects described in individual embodiments of the present specification are merely examples, and thus, there may be other effects, not limited to the exemplified effects.

Note that the present disclosure can also have the following configurations.

(1) An information processing apparatus comprising:

a management unit configured to manage a balance obtained by totaling electronic money balances held by a plurality of terminal apparatuses each being equipped with an electronic money function, as one balance to be shared among the plurality of terminal apparatuses; and

an update unit configured to update balance such that, in a case where electronic payment with the electronic money has been made using one terminal apparatus controlled to be in an electronic payment enabled mode among the plurality of terminal apparatuses, the update unit updates an amount of money obtained by subtracting an amount of used money in the electronic payment from the one balance, as a latest record of the one balance to be shared among the plurality of terminal apparatuses.

(2) The information processing apparatus according to the above (1),

wherein, in accordance with an operation by a user of the plurality of terminal apparatuses, the management unit manages the following to be linked with each other: electronic money ID identifying the electronic money; the one balance corresponding to the electronic money; and terminal ID identifying each of the plurality of terminal apparatuses.

(3) The information processing apparatus according to the above (1), further comprising:

a reception unit configured to receive selection of one terminal apparatus to be validated to enable the electronic payment among the plurality of terminal apparatuses; and

a payment control unit configured to control the selected terminal apparatus to be in an electronic payment enabled mode and control the other unselected terminal apparatuses to be in an electronic payment disabled mode.

(4) The information processing apparatus according to the above (3),

wherein the reception unit receives selection of switching one terminal apparatus to be validated to enable the electronic payment from a current terminal apparatus to another terminal apparatus, and

the payment control unit controls the terminal apparatus being a switching destination to be in an electronic payment enabled mode, and controls the terminal apparatus other than the terminal apparatus being the switching destination among the plurality of terminal apparatuses to be in an electronic payment disabled mode.

(5) The information processing apparatus according to the above (3),

wherein the reception unit further receives an access from a terminal apparatus as a validation target, being a terminal apparatus to be validated, and

when the access is received, the payment control unit determines whether an electronic money balance held by the terminal apparatus that have made the access has been updated as the latest record of the one balance.

(6) The information processing apparatus according to the above (5),

wherein the payment control unit controls the terminal apparatus that has made the access to be in the electronic payment enabled mode only in a case where the payment control unit has determined that the electronic money balance has been updated as the latest record of the one balance.

(7) The information processing apparatus according to the above (3),

wherein the payment control unit controls an access privilege corresponding to the electronic money function.

(8) The information processing apparatus according to the above (1),

wherein the one terminal apparatus controlled to be in the electronic payment enabled mode transmits payment information related to the electronic payment to the information processing apparatus in accordance with the electronic payment, and

when the update unit has acquired the payment information, the update unit provides an amount of money obtained by subtracting the amount of used money from the one balance to the one terminal apparatus being the terminal apparatus being controlled to be in the electronic payment enabled mode, and to other terminal apparatuses, being the terminal apparatuses other than the terminal apparatus controlled to be in the electronic payment enabled mode, among the plurality of terminal apparatuses, so as to allow the terminal apparatuses to hold the obtained amount of money, as the latest record of the one balance.

(9) The information processing apparatus according to the above (1), further comprising a linking unit configured to link terminal apparatuses having the electronic money function with each other in accordance with an operation of a user,

wherein the management unit manages the balance obtained by totaling the electronic money balances held by each of the plurality of terminal apparatuses linked with each other and each being equipped with the electronic money function, as a record of one balance to be shared among the plurality of terminal apparatuses linked with each other.

(10) The information processing apparatus according to the above (9),

wherein, in an initial state where the terminal apparatuses are not linked with each other, the linking unit receives, in accordance with an operation of the user, an initial setting start request from individual terminal apparatuses to be linked for the first time, and when the request for starting initial setting has been received from the individual terminal apparatuses, the linking unit executes authentication processing of authenticating identity of the user between the individual terminal apparatuses.

(11) The information processing apparatus according to the above (10),

wherein, in a state where the terminal apparatuses having the electronic money function are already linked with each other, the linking unit receives, in accordance with an operation of the user, a start request for an additional setting from another terminal apparatus to be additionally linked with a terminal apparatus group in which mutual linkage has been completed, and when the start request for the additional setting has been received, the linking unit executes authentication processing of authenticating identity of the user between the another terminal apparatus and the terminal apparatus group.

(12) The information processing apparatus according to the above (10) or (11),

wherein, when the identity of the user has been successfully authenticated by the authentication processing, the linking unit associates the identification information of each of the terminal apparatuses as linkage targets with account information of the user.

(13) An information processing method to be executed by an information processing apparatus, the method comprising:

a management step of managing a balance obtained by totaling electronic money balances held by a plurality of terminal apparatuses each being equipped with an electronic money function, as one balance to be shared among the plurality of terminal apparatuses; and

an update step of updating balance such that, in a case where electronic payment with the electronic money has been made using one terminal apparatus controlled to be in an electronic payment communication enabled mode among the plurality of terminal apparatuses, the update step updates an amount of money obtained by subtracting an amount of used money in the electronic payment from the one balance, as a latest record of the one balance to be shared among the plurality of terminal apparatuses.

(14) An information processing program for causing an information processing apparatus to execute procedures, the procedures comprising:

a management procedure of managing a balance obtained by totaling electronic money balances held by a plurality of terminal apparatuses each being equipped with an electronic money function, as one balance to be shared among the plurality of terminal apparatuses; and

an update procedure of updating balance such that, in a case where electronic payment with the electronic money has been made using one terminal apparatus controlled to be in an electronic payment communication enabled mode among the plurality of terminal apparatuses, the update procedure updates an amount of money obtained by subtracting an amount of used money in the electronic payment from the one balance, as a latest record of the one balance to be shared among the plurality of terminal apparatuses.

### Reference Signs List

1 SYSTEM
10 TERMINAL APPARATUS
14 IC CHIP
100 BALANCE MANAGEMENT APPARATUS
121 BALANCE INFORMATION STORAGE UNIT
122 LINKAGE INFORMATION STORAGE UNIT
130 CONTROL UNIT
131 RECEPTION UNIT
132 LINKING UNIT
133 MANAGEMENT UNIT
134 SELECTION RECEPTION UNIT
135 PAYMENT CONTROL UNIT
136 UPDATE UNIT

1. An information processing apparatus comprising:
a management unit configured to manage a balance obtained by totaling electronic money balances held by a plurality of terminal apparatuses each being equipped with an electronic money function, as one balance to be shared among the plurality of terminal apparatuses; and
an update unit configured to update balance such that, in a case where electronic payment with the electronic money has been made using one terminal apparatus controlled to be in an electronic payment enabled mode among the plurality of terminal apparatuses, the update unit updates an amount of money obtained by subtracting an amount of used money in the electronic payment from the one balance, as a latest record of the one balance to be shared among the plurality of terminal apparatuses.

2. The information processing apparatus according to claim 1,
wherein, in accordance with an operation by a user of the plurality of terminal apparatuses, the management unit manages the following to be linked with each other: electronic money ID identifying the electronic money; the one balance corresponding to the electronic money; and terminal ID identifying each of the plurality of terminal apparatuses.

3. The information processing apparatus according to claim 1, further comprising:
a reception unit configured to receive selection of one terminal apparatus to be validated to enable the electronic payment among the plurality of terminal apparatuses; and
a payment control unit configured to control the selected terminal apparatus to be in an electronic payment enabled mode and control the other unselected terminal apparatuses to be in an electronic payment disabled mode.

4. The information processing apparatus according to claim 3,
wherein the reception unit receives selection of switching one terminal apparatus to be validated to enable the electronic payment from a current terminal apparatus to another terminal apparatus, and
the payment control unit controls the terminal apparatus being a switching destination to be in an electronic payment enabled mode, and controls the terminal apparatus other than the terminal apparatus being the switching destination among the plurality of terminal apparatuses to be in an electronic payment disabled mode.

5. The information processing apparatus according to claim 3,
wherein the reception unit further receives an access from a terminal apparatus as a validation target, being a terminal apparatus to be validated, and
when the access is received, the payment control unit determines whether an electronic money balance held by the terminal apparatus that have made the access has been updated as the latest record of the one balance.

6. The information processing apparatus according to claim 5,
wherein the payment control unit controls the terminal apparatus that has made the access to be in the electronic payment enabled mode only in a case where the payment control unit has determined that the electronic money balance has been updated as the latest record of the one balance.

7. The information processing apparatus according to claim 3,
wherein the payment control unit controls an access privilege corresponding to the electronic money function.

8. The information processing apparatus according to claim 1,
wherein the one terminal apparatus controlled to be in the electronic payment enabled mode transmits payment information related to the electronic payment to the information processing apparatus in accordance with the electronic payment, and
when the update unit has acquired the payment information, the update unit provides an amount of money obtained by subtracting the amount of used money from the one balance to the one terminal apparatus being the terminal apparatus being controlled to be in the electronic payment enabled mode, and to other terminal apparatuses, being the terminal apparatuses other than the terminal apparatus controlled to be in the electronic payment enabled mode, among the plurality of terminal apparatuses, so as to allow the terminal apparatuses to hold the obtained amount of money, as the latest record of the one balance.

9. The information processing apparatus according to claim 1, further comprising a linking unit configured to link terminal apparatuses having the electronic money function with each other in accordance with an operation of a user,
wherein the management unit manages the balance obtained by totaling the electronic money balances held by each of the plurality of terminal apparatuses linked with each other and each being equipped with the electronic money function, as a record of one balance to be shared among the plurality of terminal apparatuses linked with each other.

10. The information processing apparatus according to claim 9,
wherein, in an initial state where the terminal apparatuses are not linked with each other, the linking unit receives, in accordance with an operation of the user, an initial setting start request from individual terminal apparatuses to be linked for the first time, and when the request for starting initial setting has been received from the individual terminal apparatuses, the linking unit executes authentication processing of authenticating identity of the user between the individual terminal apparatuses.

11. The information processing apparatus according to claim 10,
wherein, in a state where the terminal apparatuses having the electronic money function are already linked with each other, the linking unit receives, in accordance with an operation of the user, a start request for an additional setting from another terminal apparatus to be additionally linked with a terminal apparatus group in which mutual linkage has been completed, and when the start request for the additional setting has been received, the linking unit executes authentication processing of authenticating identity of the user between the another terminal apparatus and the terminal apparatus group.

12. The information processing apparatus according to claim 10 or 11,
wherein, when the identity of the user has been successfully authenticated by the authentication processing, the linking unit associates the identification information of each of the terminal apparatuses as linkage targets with account information of the user.

13. An information processing method to be executed by an information processing apparatus, the method comprising:
a management step of managing a balance obtained by totaling electronic money balances held by a plurality of terminal apparatuses each being equipped with an electronic money function, as one balance to be shared among the plurality of terminal apparatuses; and
an update step of updating balance such that, in a case where electronic payment with the electronic money has been made using one terminal apparatus controlled to be in an electronic payment communication enabled mode among the plurality of terminal apparatuses, the update step updates an amount of money obtained by subtracting an amount of used money in the electronic payment from the one balance, as a latest record of the one balance to be shared among the plurality of terminal apparatuses.

14. An information processing program for causing an information processing apparatus to execute procedures, the procedures comprising:
a management procedure of managing a balance obtained by totaling electronic money balances held by a plurality of terminal apparatuses each being equipped with an electronic money function, as one balance to be shared among the plurality of terminal apparatuses; and
an update procedure of updating balance such that, in a case where electronic payment with the electronic money has been made using one terminal apparatus controlled to be in an electronic payment communication enabled mode among the plurality of terminal apparatuses, the update procedure updates an amount of money obtained by subtracting an amount of used money in the electronic payment from the one balance, as a latest record of the one balance to be shared among the plurality of terminal apparatuses.
